(19) United States
(12) Patent Application Publication
(10) Pub. No.: US 2026/0160152 A1
(43) Pub. Date: Jun. 11, 2026

(54) A CHEMICAL REACTION HEAT SOURCE COMPOSITION FOR USE IN DOWNHOLE OPERATIONS AND ASSOCIATED APPARATUS AND METHODS

(71) Applicant: BiSN Tec Ltd., Risley, Birchwood (GB)

(72) Inventors: Andre Levchenko, Cheshire WA (GB); Billy Clark, Birchwood (GB); Clay Hughes, Birchwood (GB); Didhiti Talapatra, Birchwood (GB); Paul Carragher, Birchwood (GB)

(21) Appl. No.: 18/707,356

(22) PCT Filed: Nov. 7, 2022
(86) PCT No.: PCT/GB2022/052813

§ 371 Date: May 3, 2024

(30) Foreign Application Priority Data
Nov. 5, 2021 (GB) 2115949.6

(51) Int. Cl. E21B 36/00; C06B 23/00; C06B 47/00; C09K 8/42; C09K 8/467; C09K 8/60; E21B 27/02

(52) U.S. Cl. CPC E21B 36/008; C06B 23/001; C06B 47/00; C09K 8/426; C09K 8/467; C09K 8/60; E21B 27/02

(57) ABSTRACT

The present invention provides a fluid chemical reaction heat source composition for use in downhole operations. The present invention also provides an ignition assembly for use in initiating the reaction of the composition in a downhole environment. The present invention also provides methods of deploying heat to a downhole target region of an oil/gas well.

### FIELD OF THE INVENTION

The present invention relates to the technical field of operations in downhole environments, such as oil/gas wells, and in particular downhole operations in which a target region of a downhole environment is heated using a chemical reaction heat source.

### BACKGROUND OF THE INVENTION

A wide range of operations conducted downhole in oil/gas wells can require that heat is delivered to a downhole target region such as within an oil/gas well.

The most common types of downhole heaters used are electrical heaters, which receive power from above ground via a wireline connection, and chemical heaters, which use an on-board chemical reaction heat source that undergoes an exothermic reaction to generate heat in the target region of the oil/gas well.

The chemical heater typically comprises a container that houses a suitable amount of a chemical reaction heat source. Thermite and thermite-based mixtures are examples of a chemical reaction heat source typically employed in the chemical heaters.

One task carried out using downhole tool assemblies with chemical heating means is the clearance or removal of well structures, such as pre-existing alloy seals or portions of well tubing/casing, from within a target region of an oil/gas well. International patent application WO2015/150828 relates to assemblies used in the clearance of downhole target regions.

Another task carried out using downhole tool assemblies with chemical heating means is the deployment of alloy plugs or seals within a target region of an oil/gas well. International patent applications WO2011/151271 and WO2014/096858 disclose examples of assemblies used in the downhole deployment of alloy plugs/seals.

Typically when setting an alloy plug or seal downhole, which in most cases form a metal on metal bond with existing well structures such as well tubing or casing, a heating tool is provided in the downhole target region at the same time as a quantity of alloy.

The heat generated by the heating tool is used to melt the alloy, after which the alloy is allowed to cool and re-solidify to form an alloy plug or seal within the target region of the oil/gas well.

The process of heating a target region of an oil/gas well can be made more challenging in situations where access to the downhole target region is restricted (i.e. the wellbore is deviated or obstructed in some way), because it is more difficult to deliver the heating tool to the target region.

The problem of delivering heat downhole when faced with restricted access has been addressed in the past by reducing the size of the heating tool to produce more slim-line tools that can be delivered past downhole obstructions. International patent applications WO2017/203247 and WO2017/203248 both seek to address the issue of delivering chemical heating tools to downhole target regions within oil/gas wells that have restricted access.

### SUMMARY OF THE INVENTION

In the past the chemical reaction heat source material (e.g. Thermite) used to generate the required heat in a downhole target region would be housed within a heater body to keep the heat generating material away from the well fluids that are typically present downhole. Keeping the chemical reaction heat source material dry in this way ensures that, when the time comes, the exothermic chemical reaction material can be initiated without issue.

However, in view of the above identified problems associated with deploying heat in a downhole target region that has restricted access, and in particular oil/gas wells that are deviated and/or obstructed, the present invention provides a chemical reaction heat source composition that can be deployed directly into the well fluids of a downhole target region and still retain its ability to generate heat when the time comes. In this regard the present invention provides a chemical reaction heat source composition for use in downhole operations that is in accordance with claim 1.

In particular, the chemical reaction heat source composition, which is fluid at the temperatures found within an oil/gas wellbore, comprises: an exothermic redox mixture forming 20 to 90% by weight of the composition; a co-oxidizing agent forming 2 to 40% by weight of the composition; and a hydrophobic carrier medium forming 5 to 50% by weight of the composition; wherein the exothermic redox mixture comprises a metal that forms 5 to 50% by weight of the mixture and an oxidizing reagent that forms 50 to 95% by weight of the mixture; and wherein the co-oxidizing agent oxidises the metal of the exothermic redox mixture at a lower temperature than the oxidizing reagent.

In the composition of the present invention the bulk of the heat generated is provided by the redox reaction that takes place between the metal and the oxidizing reagent of the exothermic redox mixture.

The redox mixture component of the composition of the present invention may be thermite or thermite based and of the same types used in existing chemical heating tools. However, it is envisaged that other chemical mixtures that are capable of undergoing exothermic redox reactions might alternatively be included as the redox mixture component of the composition of the present invention.

In order to help retain the heat generating properties of the redox mixture, once it has made contact with the well fluids that populate the downhole environment of most oil/gas wells, the redox mixture is suspended in a hydrophobic carrier medium. The hydrophobic carrier medium acts to slow down the wellbore fluid's penetration into and intermixing with the redox mixture, which helps to maintain the redox mixture's heat generating properties.

The role of the co-oxidizing agent is to kick-start the redox reaction between the metal and oxidizing reagent of the redox mixture in what might otherwise be a challenging environment due to the presence of the well fluids.

It is envisaged that upon ignition of the composition by suitable ignition means, the co-oxidizing agent, which necessarily works at lower temperatures than the oxidizing reagent, begins to oxidize the metal within the redox mixture and generate heat. It is also envisaged that heat may also be generated by the reaction of the co-oxidizing agent with the hydrophobic carrier medium.

Therefore, as the initial reactions progress, the heat generated within the target region of the well provides an environment that is more conducive to commencement of the redox reaction between the metal and the oxidizing reagent, which leads to the main heat production stage.

It is envisaged that the exothermic redox mixture, which is suspended within the hydrophobic carrier medium of the composition of the present invention, may be formed from a variety of metals (essentially the ‘fuel’ for the redox reaction) and oxidizing reagents. In the broadest sense, any combination of metal and oxidizing reagent that undergo a redox reaction that produces heat energy (i.e. an exothermic reaction) are considered to fall within the general scope of the present invention.

However, preferably the metal in the exothermic redox mixture may be selected from: AI, B, Ta, Ti, Mg, AISi, and AIMg.

Additionally or alternatively, the oxidizing reagent in the exothermic redox mixture may be a metal oxide, wherein preferably the metal oxide is selected from: CuO, Cu₂O, Cr₂O₃, WO₃, Fe₂O₃, Fe₃O4, MnO₂, Bi₂O₃, MoO₃, and PbO₂.

Further preferably, the exothermic redox mixture may be either thermite or thermite based. Thermite/thermite based mixtures are considered particularly preferable because of their high energy density and their ability to generate large amounts of heat in relatively short periods of time.

Preferably the co-oxidizing agent may be selected from a group consisting of nitrates, permanganates, chlorates, perchlorates, sulphates and fluoropolymers. These chemical compounds tend to act as oxidizers of the metal fuel at lower temperatures than metal oxides, which are the preferred choice of oxidizing reagent used in the exothermic redox mixture of the present invention.

Examples of preferred co-oxidizing agents include: potassium and sodium nitrates; potassium permanganate; barium and calcium sulphates; potassium and sodium chlorates; ammonium perchlorate, potassium perchlorate, sodium perchlorate; and polytetrafluoroethylene.

Preferably the hydrophobic carrier medium may be: a) an organic plant-based oil selected from canola oil, linseed oil, peanut oil, avocado oil, and combinations thereof; b) a petroleum/fuel oil selected from diesel, kerosene, low aromatic base oils, and combinations thereof; c) a synthetic oil selected from poly-alpha-olefins, polyalkylene, glycol, and combinations thereof; d) a silicon oil in the form of polydimethylsiloxane; and e) a combination of the oils identified in a) to d).

Preferably the composition of the present invention may further comprise a dampening agent that forms up to 30% by weight of the composition.

It is envisaged that the inclusion of a dampening agent, such as CaO, Al₂O₃, SiO₂, MnO₂, CaF₂, can be used to control the temperature and burn rate of the composition.

It is appreciated that gas can be generated during the reaction of the composition. This may or may not be desirable depending on the set up of the wellbore.

In view of this the composition may further comprise a gas absorbing agent that forms up to 30% by weight of the composition; and wherein the gas absorbing agent is selected from a group consisting of Bi₂O₃ and CaO.

It is envisaged that the inclusion of gas absorbing agents in the composition can help to control the levels of gas generated during the progression of the redox reaction downhole.

Preferably the composition may further comprise additives that facilitate the formation of metal plugs/barriers in a downhole target region by melting existing well structures (e.g. well tubulars, cement, and formations materials) and using both the melted well structures and the residue from the exothermic reaction of the composition to form a plug within said target region.

In particular, the barrier formation additives include metals such as bismuth, tin, silver, antimony, copper, iron, zinc, aluminium, magnesium, manganese, silicon, germanium, nickel, or any combination of these materials and their oxides.

It is envisaged that by including one or more of the listed metals (or their oxides) in the composition it is possible to incorporate the metals, or more particularly alloys of the metals, into the metal plug to enhance its gas-tight characteristics.

The barrier formation additives may also include inorganic and organic acids and materials that decompose to form these acids. It is envisaged that acids serve as alloy surface activators that enhance the quality of the metal plug formed within the target region of the oil/gas well and in so doing enhance the gas-tight characteristics of the metal plug.

Examples of suitable acids includes hydrochloric acid, acetic acid, hydrofluoric acid, adipic acid, citric acid, glutaric acid, carboxylic and dicarboxylic acids, phosphoric acid, rosin, oleic acid, and steric acid. Materials that decompose to form acids could include but not limited to PTFE (polytetrafluoroethylene), PVC (polyvinyl chloride), and PMAA (poly methacrylic acid).

Inert fillers and other active ingredients that be used in conjunction with the acids include parrifinic hydrocarbons, zinc chlorides, ammonium chloride, and ammonium bifluoride.

As noted above, the composition of the present invention is fluid at the temperatures found in downhole environments, which tend to stay below 177° C. and are usually within the temperature range of 5-110° C. This ensures that the composition can be readily delivered downhole to a target region using convenient delivery methods, such as pumping. Preferably the physical state of the composition in the downhole environment is selected from a liquid (including shear thinning liquids), a paste, a gel.

It is envisaged that, although the composition of the present invention is intended to be capable of being initiated downhole when it is delivered directly into the well fluids in a downhole target region, the composition may also be delivered downhole using more traditional heating tools, wherein the composition is housed within a heater body when it is initiated.

With that said, the main focus of the present invention is to provide compositions that can be delivered directly into the well fluids of an oil/gas wellbore and then initiated to generate heat in the target region.

In view of this, in a further aspect, the present invention provides a method of heating a target region of an oil/gas well, said method comprising: a) delivering a chemical reaction heat source composition according to present invention into direct contact with well fluids located in the target region of the oil/gas well; and b) initiating the redox chemical reaction of the composition to generate heat within the target region.

Preferably the composition may be pumped to the target region, and further preferably the composition may be pumped downhole via coiled tubing or via the inner diameter of a well tubing of the oil/gas well.

Alternatively the composition may be delivered to a downhole target region by using a dump bailer that is deployed downhole.

The greater range of delivery options means that the chemical reaction heat source composition can be efficiently delivered downhole to a target region even in oil/gas wells that are deviated or/and which comprise obstructions in the delivery path that leads to the target region. In particular, it is appreciated that pumping the composition downhole requires much less well access than would be required to deliver a corresponding amount of a chemical reaction heat source material housed within a heating tool.

Consequently, the composition of the present invention allows for the provision of downhole heating in operations that are carried out in oil/gas wells with restricted access.

In those embodiments where the composition is delivered downhole in a dump bailer, it is envisaged that the dump bailer may form part of larger downhole tool assembly that also comprises means (e.g. an ignition assembly) for initiating the reaction of the chemical reaction heat source composition.

Alternatively the dump bailer may be deployed separately and retrieved before an ignition assembly is subsequently deployed downhole to initiate the reaction of the chemical reaction heat source composition.

Additionally, in cases where the heat is employed to melt alloy to form an alloy plug or seal within the target region, the downhole tool assembly may further comprise a quantity of a suitable alloy, such as a bismuth-based alloy, a eutectic alloy, or a low melting point alloy.

Preferably the method may further comprise: monitoring the environmental conditions in the target region following the initiation of the composition; and adjusting the chemical reaction characteristics of the composition by delivering additional chemical agents to the target region as the redox chemical reaction progresses.

It is envisaged that the additional chemical agents might be deployed from a dump bailer located above the target region. Alternatively the additional chemical agents could be circulated in from the end of tubing or coiled tubing.

Examples of suitable additional chemical agents include: dampening agents, gas absorbing agents; plug formation additives; and combinations thereof.

It is envisaged that the step of initiating the heat generating chemical reaction of the composition of the present invention may be achieved in a variety of ways.

However, preferably the step of initiating the redox chemical reactions may comprise: i) delivering a contained heat source to the target region of the oil/gas well; and ii) activating the contained heat source to heat the target region and initiate the redox chemical reaction of the composition.

It is anticipated that, because the primary purpose of the contained heat source in this embodiment is merely to create sufficient heat energy to initiate a redox chemical reaction in the composition, the container used to deliver the heat source downhole can be made more compact. That is, when compared to a container that is required to accommodate the chemical reaction heat source that serves as the main source of heat generation in the downhole target region.

This ability to make the container more compact makes it much easier to deploy the contained heat source downhole, even in oil/gas well that are deviated or/and which comprise obstructions.

Although an electrical heat source may be employed, preferably the contained heat source comprises a chemical reaction heat source housed within an ignition assembly housing.

Further preferably, the housing may be configured to permit the escape of the chemical reaction heat source contained therein under the increased temperatures and pressures generated following the activation of the chemical reaction heat source mixture.

To this end, the housing is preferably formed, at least in part, from a material that is configured to melt and/or rupture at the increased temperatures and pressures generated by the contained chemical reaction heat source mixture.

Examples of suitable materials for the ignition assembly housing include, but are not limited to, aluminium and various grades of steel. In addition, it is envisaged that the wall thickness of the housing, either in part or a whole, could be selected to make it more susceptible to melting through.

It is envisaged that configuring the housing to melt and/or rupture permits the reacting chemical reaction heat source to escape and mix directly with the uncontained chemical reaction heat source composition found in the well fluid of the target region, which enhances the initiation of the composition.

In addition, the present invention provides a method of clearing or removing a well structure from a target region of an oil/gas well by heating the target region using the general heating method described above.

Preferably the well structure to be cleared or removed may be selected from a group that consists of: well tubing; well casing; previously deployed well tools; cabling, tubing and other lines deployed within the oil/gas well.

Preferably the method may further involve perforating the well structures prior to the heating stage. It is envisaged that pre-perforating the well structures, such as the well tubing/casing can help to enhance the heating effect achieved by the composition of the present invention.

Preferably the method may further comprise the deployment of insulating means above and/or below the target region prior to the initiation of the composition.

The insulating means may comprise: a mechanical tool, such as an expandable baffle, a packer or a bridge plug; and/or an insulating fluid.

In a further aspect, the present invention provides a method of deploying a metal plug within a target region of an oil/gas well, said method comprising: a) heating the target region using the general heating method described above; and b) using the heat generated by the composition to melt metal(s) within the target region, before allowing the molten metal(s) to cool within the target region and form the plug.

It is envisaged that the residues of the heat generating chemical reaction of the chemical heat source composition can play a part in the formation of the metal plug.

The residues of the heat generating chemical reaction can also combine with material sourced from existing well elements in the target region of the oil/gas well. Examples of well elements include tubulars such as well casing, tubing, and liners, which are generally made of metal.

It is appreciated that the metal from well elements within the target region is melted by the heat generated by the composition and then, when it cools, the metal forms a component of the metal plug along with the residues from the chemical heat source composition.

In cases where the composition is delivered downhole within a heater body housing, the material of the housing may also form part of the metal plug.

Additionally, other materials found in the target region, such as cement and formation materials, can also form part of the metal plug.

It is appreciated that the barrier qualities of the metal plug formed by the combination of the chemical heat source composition and the melted well elements may not be sufficient to guarantee a gas tight seal/barrier within the target region.

In view of this is envisaged that barrier formation additives may be added to the chemical reaction heat source composition in order to supplement the gas-tight characteristics of the metal plug formed within the target region.

The barrier formation additives include the metals bismuth, tin, silver, antimony, copper, iron, zinc, aluminium, magnesium, manganese, silicon, germanium, nickel, or any combination of these materials and their oxides.

It is envisaged that by including one or more of the listed metals (or their oxides) in the composition it is possible to incorporate the metals, or more particularly alloys of the metals, into the metal plug to enhance its gas-tight characteristics.

The barrier formation additives may also include inorganic and organic acids as well as materials that decompose to form these acids. It is envisaged that these acids serve as alloy surface activators that enhance the quality of the metal plug formed within the target region of the oil/gas well.

Examples of suitable acids includes hydrochloric acid, acetic acid, hydrofluoric acid, adipic acid, citric acid, glutaric acid, carboxylic and dicarboxylic acids, phosphoric acid, rosin, oleic acid, and steric acid. Materials that decompose to form acids could include but not limited to PTFE (polytetrafluoroethylene), PVC (polyvinyl chloride), and PMAA (poly methacrylic acid).

Inert fillers and other active ingredients that be used in conjunction with the acids to aid their deployment include parrifinic hydrocarbons, zinc chlorides, ammonium chloride, and ammonium bifluoride.

Alternatively or additionally the metal plug may be supplemented by subsequently deploying a molten alloy onto the metal plug and then allowing the alloy to cool. Further preferably the alloy may comprise a bismuth-based alloy, a eutectic alloy or a low melting point alloy.

It is envisaged that the metal plug, which may not be gas tight without the use of barrier formation additives, at very least serves as a base for the alloy to be deployed onto. Once the alloy is allowed to cool and resolidify, a plug with a gas tight seal can be formed.

As noted above, once the composition of the present invention has been delivered to a downhole target region it can be initiated to commence the exothermic chemical reaction that generates the required heat in the target region. The heat generated by the composition can be used in a range of downhole operations, including the clearing/removal/destruction of well structures, the formation of metal plugs/seals, and in some cases a combination of both by using existing well structures (e.g. well tubulars) to help form plugs/seals within a downhole target region.

To this end, another aspect of the present invention provides an ignition assembly for use in initiating a chemical reaction heat source to undergo a redox reaction in a downhole environment, said ignition assembly comprising: a housing containing heating means configured to generate sufficient heat energy to initiate a redox reaction in a chemical reaction heat source; a piston that is movable from a default position to an active position in which the piston activates the heating means; wherein, when the pressure acting on the piston exceeds a predetermined level, the piston moves from the default position to the active position and activates the heating means.

It is envisaged that, although the ignition assembly described herein is considered particularly suitable for use in initiating the chemical reaction in the composition of the present invention when it has been delivered directly into the well fluids of a target region, the above-described ignition assembly could also be employed to initiate more traditional chemical reaction heat sources; such as the contained solid heater blocks and fragmented solid heater blocks (i.e. crumble) described in international patent applications WO2014/096857 and WO2017/191471.

In addition, the ignition assembly could also be used to initiate the composition of the present invention when it is housed within a heater body of a more traditional heating tool.

Preferably the piston is arranged in fluid communication with the exterior of the housing such that the piston moves from the default position to the active position when the pressure applied to the exterior of the housing exceeds the predetermined level.

The described ignition assembly is configured to be activated by the action of pressures incident on the exterior of the ignition assembly. It is envisaged that because the pressure imparted downhole tends to increase with the downhole depth, not least due the weight of well fluids pressing down under the force of gravity, in its most basic embodiments the ignition assembly of the present invention can be configured to activate the heating means when it reaches a certain downhole depth.

Alternatively, the piston of the ignition assembly may be configured to move only when it is exposed to a pre-determined pressure level that is above the ambient pressure levels found at the depth of the target region.

In this case, the activation of the ignition assembly can be achieved by taking steps to increase the pressure within the target region. It is envisaged that pumps at the surface can be employed to increase the well pressure as a whole This allows an operator to control the activation of the ignition assembly remotely.

In a further alternative, the ignition assembly comprises a coiled tubing connection point that facilitates the attachment of coiled tubing to enable the delivery of the assembly downhole; and wherein the piston is arranged in fluid communication with said coiled tubing via said connection point.

In this way, the coiled tubing can be used to apply pressure directly to the piston to activate the assembly from above ground without the need to increase the pressure within the whole target region.

Preferably the piston may be retained in its default position by the action of resilient biasing means and/or a shear pin. In this way the piston cannot move until sufficient force is applied, for example by the environmental pressure in the target region or by the pressure applied via the pipe/coiled tubing.

Alternatively, or additionally, the housing of the ignition assembly may be provided with a conduit that is blocked by a rupture disk that is configured to rupture when the pressure acting on it exceeds the predetermined level; and wherein the rupture of the rupture disk facilitates fluid communication between the piston and the exterior of the housing via said conduit.

In this way the predetermined pressure at which the ignition assembly is activated can be specifically controlled by selecting the appropriate rupture disk.

It is envisaged that the action of the piston can be translated into heat to initiate the composition in a variety of ways.

In one example, the heating means may preferably comprise a piezoelectric transducer, a capacitor and a heating element; and wherein the action of the piston on the piezoelectric transducer creates a voltage that charges the capacitor, which is subsequently discharged to energise the heating element and generate heat to initiate the redox reaction.

It is envisaged that the ignition assembly may preferably form part of a downhole tool assembly that also comprises a chemical heater. In such arrangements the heating element may be used to heat the chemical reaction heat source held within the chemical heater and initiate the operation of the chemical heater.

The heat given off by the chemical heater can then be used to initiate the chemical reaction heat source composition within the well fluid. It is envisaged ignition assembly's ability to initiate the composition may be further enhanced by configuring the chemical heater to permit the reacting chemical reaction heat source to escape into the surrounding composition.

For the sake of completeness it is noted that in situations where access to the downhole target region is not restricted, the chemical heater of the downhole tool assembly described herein may be configured to act as the primary heat source.

In an alternative example, the heating means of the ignition assembly may preferably comprise an injection mechanism loaded with a chemical ignition mixture and a reservoir of redox mixture comprising a metal and an oxidizing reagent; and wherein the action of the piston on the injection mechanism brings the chemical ignition mixture into contact with the redox mixture and thereby initiates a heat generating chemical reaction of the redox mixture.

Generally speaking the chemical ignition mixture employed must be capable of generating a high amount of heat energy very quickly so that it can kick-start the chemical reaction within the reservoir of redox mixture. Examples of suitable chemical ignition mixtures include: 9% barium nitrate, 39% red thermite 325 mesh, 12% sulphur; and a sulfuric acid and potassium chlorate mix.

As noted above the ignition assembly may be delivered downhole using coiled tubing. However it is envisaged that other suitable delivery support means include electric line and tubing.

In order to further increase their reliability downhole it is envisaged that the ignition means may be provided with built-in redundancy in the form of multiple self-contained heating means (e.g. electrical heating element or ignition mix). It is envisaged that each self-contained heating means may be activated by a separate pressure actuated piston or by a single common piston.

It those embodiments where multiple pistons are employed, it is considered of further benefit if each piston communicates with the exterior of the ignition assembly housing via its own conduit and that each conduit is provided with its own rupture disk.

It is further appreciated that, in those embodiments with multiple heating means, different types of heating means can be used in combination.

### BRIEF DESCRIPTION OF THE DRAWINGS

The present invention will now be described with reference to the drawings, wherein:

FIG. 1 shows a downhole heating operation carried using a chemical reaction heat source composition of the present invention with a downhole tool assembly that comprises an ignition assembly;

FIG. 2 shows a downhole heating operation carried using a chemical reaction heat source composition of the present invention with an alternative downhole tool assembly that comprises an ignition assembly; and FIG. 3 shows a cross-sectional view of the ignition assembly that forms part of the downhole tool assembly shown in FIG. 2.

### DETAILED DESCRIPTION OF THE PREFERRED EMBODIMENTS OF THE PRESENT INVENTION

The present invention provides a fluid chemical reaction heat source composition that is suitable for use in heating a downhole target region in which fluid are resident. Although it is appreciated that the composition of the present invention is suitable for use in a range of downhole environments, the inventors consider that the main use for the composition is in downhole heating operations conducted within oil/gas wells.

As noted above, two examples of downhole operations that employ the deployment of heat are: the clearance or removal of well structures, such as pre-existing alloy seals or portions of well tubing/casing, from within a target region of an oil/gas well; and the deployment of alloy plugs or seals within a target region of an oil/gas well. It is also envisaged that such operations can also be carried out in combination with heat being used to recondition existing well structures and use them to form plugs/barriers within a target region of an oil/gas well.

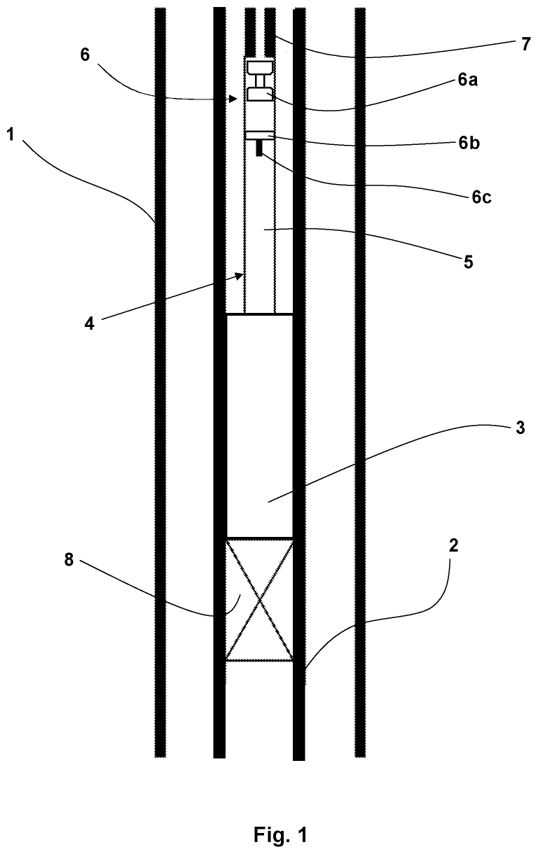

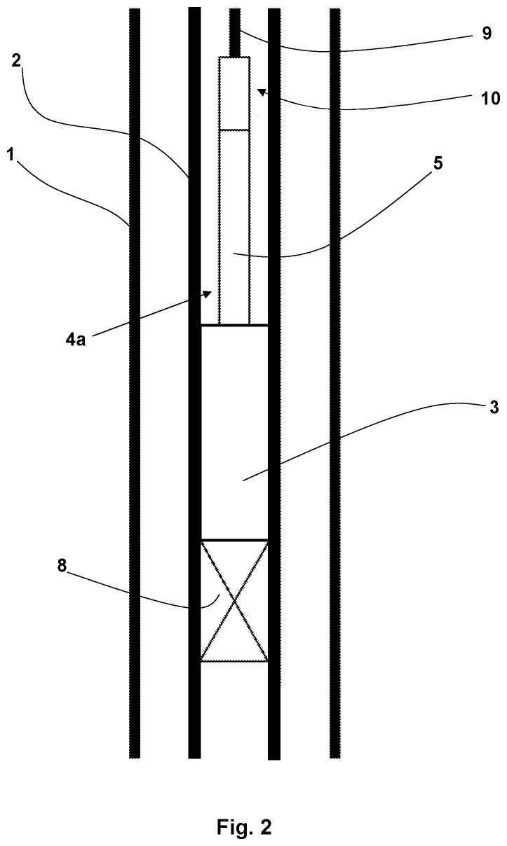

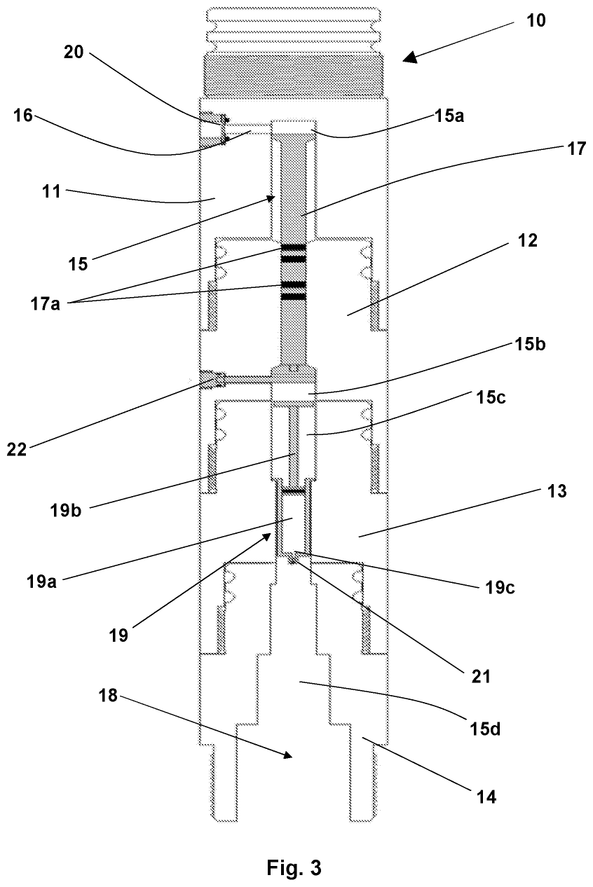

The preferred embodiments of the present invention shown in FIGS. 1 and 2 relate to the clearance/removal of well structures. However, it is envisaged that heat deployed within the inner diameter of a well tubing in the manner shown could also be used to melt a Thermally Deformable Annular Packer (TDAP) that is located in the annulus between the well tubing and the well casing. TDAPs are described in more detail in international PCT applications WO2016/024122 and WO2016/024123.

Further, it is also envisaged that the well structures being melted in the embodiment shown in FIGS. 1 and 2 could also be used in the formation of a plug within the target region. Said plug that could form the platform for an alloy-based barrier seal. Alternatively the barrier formation additives could be added to the chemical heat source composition to supplement the gas tight barrier characteristics of the metal plug formed within the target region of the oil/gas well.

The chemical reaction heat source composition of the present invention is intended to be fluid at the temperatures typically found in downhole environments (e.g. below 177° C.). This means that the composition can be readily deployed downhole to the region of the oil/gas well that has been targeted for heating.

In particular, the fluid state of the composition, which may be in the form of a liquid, a paste or even a gel, means that it can be pumped downhole directly into the target region using suitable conduits that extend from the surface of the well to the downhole target region (e.g. the coiled tubing used to deliver a tool downhole or the inner diameter of the well tubing itself).

In existing downhole chemical heaters, chemical reaction heat sources (e.g. thermite/thermite-based mixture) are typically enclosed, or contained, within a housing that isolates the chemical mixture from the well fluids that are present down hole.

Isolating the chemical reaction heat source in this way prevents the well fluids from impeding the exothermic redox reaction of the chemical mixture that is fundamental to the heat generation process that is achieved by chemical reaction heat sources, such as thermite.

In contrast to existing chemical heating technologies, the present invention provides a chemical reaction heat source in the form of a composition that can be delivered downhole in an uncontained form, such that it is delivered into direct contact with the well fluids in the target region. This approach is in direct contrast with traditional downhole heating tools, because the composition is not initiated whilst enclosed within a protective housing but rather when it is in direct contact with the well/wellbore fluids.

In order to mitigate the impeding effects of the well fluids, the core components of the chemical reaction heat source (i.e. the exothermic redox mixture of a metal and an oxidizing reagent) are suspended within a hydrophobic carrier medium that acts to greatly reduce the extent to which the well fluid in the downhole target region can interact with the exothermic redox mixture.

The composition of the present invention includes a co-oxidizing agent in addition to the oxidizing reagent of the core redox mixture. Importantly the co-oxidizing agent is selected to have the ability to oxidize the metal of the core redox mixture at a lower temperature than the oxidizing reagent.

In this way, upon initiation of the composition, the co-oxidizing agent is better suited than the oxidizing reagent to react with the metal of the redox mixture and generate heat.

The heat generated by the initial reaction between the co-oxidizing agent and the metal helps to increase the temperature within the target region of the well and in so doing creates conditions that is more accommodating to a main redox reaction between the metal and the oxidizing reagent. Once initiated, the reaction of between the metal and oxidizing reagent (e.g. thermite) acts as the composition's main source of heat production within the target region.

It is envisaged that during the early stages, additional heat may also be generated by the reaction of the co-oxidizing agent with the hydrophobic carrier medium.

Preferred examples of the various components that make up the chemical reaction heat source composition of the present invention have been described above. In view of this, it is envisaged that the identified components can be combined in a range of mixtures and quantities to deliver different heat outputs within the downhole target region.

By way of an example, one preferred composition of the present invention comprises:
59.4% by weight of the composition is redox mixture, wherein the redox mixture is formed from 33.7% by weight of the mixture is Aluminium and 66.3% by weight of the mixture is Iron oxide;
19.8% by weight of the composition is sodium nitrate; and
20.8% by weight of the composition is an oil based mud fluid that contains a low aromatic base oil. One example of suitable oil based mud fluid is produced by ExxonMobil under the trade name Escaid™.

This composition has been found to generate temperatures in excess of 2000° C. in downhole conditions where well fluids are present. This level of heating is sufficient to melt a wide range of well structures (e.g. well casing and well tubing).

It is envisaged that once the chemical reaction heat source composition of the present invention has been delivered into direct contact with the well fluids within the downhole target region there are a range of ways of initiating the composition to begin generating heat. With that said, the ignition assembly provided in accordance with the present invention is considered particularly suitable for this purpose.

The downhole operation of the ignition assembly of the present invention and the chemical reaction heat source composition of the present invention will now be described with reference to the drawings.

FIG. 1 shows a downhole hole target region of an oil/gas well that comprises an outer well casing 1 and an inner well tubing 2. The well tubing 2 is closed off using a plug 8, which is preferably provided in the form of a packer or a bridge plug. However, alternative methods for forming the base within the target region will be appreciated by the skilled person.

The plug 8 provides a base onto which the chemical reaction heat source composition 3 of the present invention can be deployed. It is envisaged that the composition may be pumped downhole via the coiled tubing 7 that is used to deliver the ignition assembly 4 to the target region. However, it is also envisaged that the composition 3 may alternatively be pumped downhole via the inner diameter of the well tubing 2.

In a further alternative delivery approach the composition may be delivered downhole within a dump bailer and then deployed therefrom onto the plug 8.

Once the composition is in position within the target region it can be initiated to commence the exothermic chemical reaction that heats the target region. In the preferred embodiment shown in FIG. 1 this is achieved using an ignition assembly 4.

The ignition assembly 4, which is delivered downhole using a coiled tubing 7, comprises a heater body 5, which houses a reservoir of a chemical reaction heat source (e.g. thermite), and a piezoelectric ignition sub 6, which is configured to trigger the reaction of the chemical reaction heat source contained within the heater body 5.

It is envisaged that the design of the heater body 5 may be similar to that of more traditional chemical heating tools, albeit on a smaller scale because the role of the heater body 5 is merely to generate enough heat to initiate the chemical reaction of the uncontained composition 3. As such, the heater body does not need to house a large volume of chemical reaction heat source.

The piezoelectric sub 6 essentially comprises a mechanism for converting a pressure wave, sent from the surface to the ignition assembly 4 via the coiled tubing 7, into heat that commences the reaction of the contained chemical heat source.

The piezoelectric sub 6 comprises a piston 6a that is configured to move from a default position to an active position under the application of a pressure pulse/wave delivered downhole via the coiled tubing.

It is envisaged that the piston 6a may be retained in the default position by way of a shear pin that is designed to fail when subjected to a predetermined force. Alternatively, the piston may be urged towards the default position by resilient biasing means, such as a coiled spring.

Upon moving from the default position to the active position, the piston strikes a piezoelectric transducer 6b, which translates the mechanical force of the piston strike into a voltage that charges a capacitor.

The capacitor is then discharged to energise a heating element 6c, which generates the heat necessary to initiate the chemical reaction source contained within the heater body 5.

The heater body 5 of the ignition assembly 4 is positioned in close proximity to, and preferably in direct contact with, the composition 3 so that the heat generated by the contents of the heater body can initiate the chemical reaction of the composition 3 located in the target region.

Preferably, although not essentially, the heater body may be configured to melt or rupture during the reaction of the contained chemical heat source to allow the contained chemical heat source to escape into the composition 3 that surrounds the heater body 5. The direct contact between the contained chemical heat source from the heater body and the uncontained composition further enhances the initiation of the composition 3 within the well fluids of the target region.

It should be appreciated that the ignition assembly 4 is not necessarily shown to scale in FIG. 1 and the size of the ignition assembly may be much smaller relative to the volume of the composition 3. This can be achieved because the heater body 5 only needs to accommodate a heat source that is capable of generating sufficient heat to initiate the composition 3. Once the chemical reaction of the composition 3 has been initiated, it is this reaction that generates the bulk of the heat required for the downhole heating operation.

The ability to greatly reduce the size of the ignition assembly 4 (and its heater body 5) makes it easier to deliver the ignition assembly to a downhole target region; even in wells that are highly deviated and/or which have restricted access (e.g. obstructed).

Thus, when used in concert with the pumpable chemical reaction heat source composition of the present invention, the ignition assembly of the present invention facilitates the delivery of a significant amount of heat to a downhole target region without requiring the downhole deployment of a large chemical heating tool.

The heat generated in the target region of the oil/gas well shown in FIG. 1 can be used to melt the well tubing 2 and possibly also the well casing 1.

FIG. 2 shows an alternative embodiment of the ignition assembly 4a of the present invention in use downhole heating operations, such as the clearance or removal of well structures.

As in FIG. 1, a quantity of chemical reaction heat source composition 3 is delivered downhole onto the plug 8 that is provided within the well tubing 2.

The ignition assembly 4a is again delivered downhole such that it is brought into close proximity with the composition. In the embodiment shown in FIG. 2, the ignition assembly 4a is delivered downhole using a wireline 9 as the delivery support.

Ignition assembly 4a, which employs an alternative approach to initiating the chemical reaction in composition 3, comprises a mechanical ignition sub 10 and a heater body 5 that once again houses a suitable chemical reaction heat source (e.g. thermite).

The manner in which the mechanical ignition sub 10 operates differs from that of the piezoelectric ignition sub 6 described above with reference to FIG. 1. In this regard the mechanical ignition sub 10 employs a high energy ignition mixture rather than a heating element to initiate a chemical reaction in the chemical reaction heat source contained in the heater body 5.

A preferred example of the mechanical ignition sub 10 will now be described with reference to FIG. 3.

The mechanical ignition sub 10 comprises a series of stacking body components 11, 12, 13 and 14 that are configured to be threaded together to form the main body of the sub.

It is appreciated that forming the mechanical ignition sub 10 from a series of threaded body components can make the manufacture and construction of the sub easier. With that said, it is envisaged that the main body of the mechanical ignition sub 10 may be formed from fewer components or even a single main body construction. Body components 11, 12, 13 and 14 screw together to define a longitudinal conduit 15 that extends along the central axis of the sub 10 from a pressure port 16 in body component 11 to a heater body access chamber 18 provided by body component 14.

Each body component contributes a portion of the conduit, with conduit portions 15a, 15b, 15c and 15d being located in body components, 11, 12, 13 and 14 respectively.

A piston 17, is slidably mounted within the conduit 15 that is defined by body components 11 and 12.

In addition, an ejection mechanism 19 is also provided within the portion of the conduit 15 that is defined by body component 13. The ejection mechanism 19 comprises a chamber 19a with an ejection port 19c and plunger 19b that is arranged to urge the contents of the chamber out of the ejection port.

The chamber 19a of the ejection mechanism 19 houses a quantity of a high energy ignition mixture (e.g. a mixture of 9% barium nitrate, 39% red thermite 325 mesh, 12% sulphur; or a sulfuric acid and potassium chlorate mix).

One head of the piston 17 is provided in fluid communication with pressure port 16 and the other head of the piston is provided in fluid communication with the plunger 19c of the ejection mechanism 19.

The shaft of the piston 17 is provided with multiple seals 17a in order to prevent fluid communication between the conduit portion 15a/pressure port 16 and the conduit portion 15b/ejection mechanism 19.

Prior to the activation of the ignition sub 10, the pressure port 16 is closed off by a burst disk 20. The burst disk 20 is configured to rupture at a pre-determined pressure and in so doing allow the flow of well fluid into the conduit 15, where it acts on the head of the piston 17.

Although not shown in FIG. 3, it will be appreciated that when the mechanical ignition sub 10 is attached to the heater body 5 (see FIG. 2) the heater body access chamber 18 communicates directly with the chemical reaction heat source (e.g. thermite) housed in the heater body 5. In fact, it is envisaged that in alternative embodiments of the present invention the body component 14 may form part of the tubing of the heater body 5.

Before activation of the ignition sub 10, the contents of the ignition mix chamber 19a are kept separate from the chemical reaction heat source held within chamber 18 and the heater body (not shown) by a plug 21 provided on the ejection port 19b.

The pressure activated operation of the mechanical ignition sub 10 will now be described with reference to the preferred embodiment shown in FIG. 3. It is envisaged that the pressure activation can be either passive or active.

In the case of the passive activation, once the ignition assembly is in situ downhole the pressure within the target region can be used to rupture the burst disk and open pressure port 16 so that the well fluids can enter ignition sub 10. In this arrangement the pre-determined rupture pressure of the burst disk 20 is selected to fail at the ambient fluid pressure found at the downhole depth of the target region.

Alternatively, in embodiments where active activation of the ignition assembly is required, the pre-determined rupture pressure of the burst disk 20 may be selected to fail at level that is above the ambient pressure. In this case, the pressure within the target region can be increased by the operation of pumps at the surface of the well in order to trigger the activation of the ignition assembly.

In both the passive and the active embodiments of the present invention, the rupture of the burst disk 20 allows the well fluid within the target region to enter the upper portion 15a of the conduit via the pressure port 16, wherein it acts to urge the piston 17 from a default position to an active position, in which the piston 17 acts on the plunger 19b of the ejection mechanism 19.

The action of the plunger 19b being urged into the chamber 19a causes the ignition mix to bust the plug 21 and exit the ignition mix chamber 19a via the ejection port 19c and enter into contact with a chemical reaction heat source found in the heater body access chamber 18 and the heater body 5.

The introduction of the ignition mix into the chemical reaction heat source serves to initiate the heat generation reaction within the heater body 5.

As described above, following the commencement of the chemical reaction of the chemical reaction heat source within the heater body 5, the heat generated serves to initiate the exothermic reaction of the uncontained chemical reaction heat source composition 3 located in the target region surrounding the ignition assembly 4a.

Again, it is preferable that the heater body is configured to melt or rupture during the reaction of the contained chemical heat source to allow its contents to escape into the composition 3 that surrounds the heater body 5. This enhances initiation of the composition 3 within the well fluids of the target region.

Although not shown in the figures, it is envisaged that at least piston 17 may be resiliently biased towards the default position, in which it is does not press against the plunger 19b of the ejection mechanism 19. In this way, the accidental ignition of the contents of the heater body is prevented until such time as a sufficient pressure is brought to bear on the piston 17. Alternatively, a shear pin may be provided to retain the piston in the default position until the activation pressure is reached.

A further safety measure is provided in the form of locking pin 22, which is inserted across the conduct 15 at a point between the piston 17 and the plunger 19b of the ejection mechanism 19. The insertion of the locking pin 22 prevents the piston inadvertently coming into contact with the plunger 19b during transit and triggering the initiation of the contents of the heater body.

It will be appreciated that once the ignition assembly is ready to be deployed downhole, the locking pin 22 can be removed.

It is noted that, although the piezoelectric sub 6 is employed on an ignition assembly that is delivered downhole using a coiled tubing as the delivery support, an ignition assembly with a piezoelectric sub 6 could also be delivered downhole using an alternative delivery support (e.g. wire lines).

In such arrangements the piezoelectric transducer of the sub 6 may be triggered by an electrical signal communicated downhole via the wire line rather than by a pressure signal.

Similarly the mechanical sub 10 could be employed on an ignition assembly that is delivered downhole using coiled tubing without departing from the scope of the present invention.

In those embodiments where coiled tubing is used, it is envisaged that the coiled tubing could be used instead of the well fluid within the target region to operate the piston 17 causes an ignition mix to be ejected from the ejection mechanism 19. To this end coiled tubing and the pressure port could be provided in fluid communication with one another-albeit with the temporary barrier of a burst disk.

Although not shown in the figures, it is envisaged that the ignition assembly may comprise more than one activation system (i.e. piezoelectric or mechanical) to allow for a backup trigger in cases where the main activation system fails. The backup activation system may be of the same type as the main activation system or it could be of a different type.

1. A chemical reaction heat source composition for use in downhole operations, wherein said composition, which is a fluid at the temperatures found within an oil/gas wellbore, comprises:
an exothermic redox mixture forming 20 to 90% by weight of the composition;
a co-oxidizing agent forming 2 to 40% by weight of the composition; and
a hydrophobic carrier medium forming 5 to 50% by weight of the composition;
wherein the exothermic redox mixture comprises a metal that forms 5 to 50% by weight of the mixture and an oxidizing reagent that forms 50 to 95% by weight of the mixture; and
wherein the co-oxidizing agent oxidizes the metal of the exothermic redox mixture at a lower temperature than the oxidizing reagent.

2. The composition of claim 1, wherein the metal in the exothermic redox mixture is selected from: AI, B, Ta, Ti, Mg, AISi, and AIMg.

3. The composition of claim 1 or 2, wherein the oxidizing reagent in the exothermic redox mixture is a metal oxide, and wherein preferably the metal oxide is selected from: CuO, Cu₂O, Cr₂O₃, WO₃, Fe₂O₃, Fe₃O₄, MnO₂, Bi₂O₃, MoO₃, and PbO₂.

4. The composition of claim 1, 2 or 3, wherein the exothermic redox mixture is either thermite or thermite based.

5. The composition of claim 1, 2, 3 or 4, wherein the co-oxidizing agent is selected from a group consisting of nitrates, permanganates, chlorates, perchlorates, sulphates and fluoropolymers.

6. The composition of any one of claims 1 to 5, wherein the co-oxidizing agent is selected from potassium and sodium nitrates; potassium permanganate; barium and calcium sulphates; potassium and sodium chlorates; ammonium perchlorate, potassium perchlorate, sodium perchlorate; and polytetrafluoroethylene.

7. The composition of any one of claims 1 to 6, wherein the hydrophobic carrier medium is:
a) an organic plant-based oil selected from canola oil, linseed oil, peanut oil, avocado oil, and combinations thereof;
b) a petroleum/fuel oil selected from diesel, kerosene, low aromatic base oils, and combinations thereof;
c) a synthetic oil selected from poly-alpha-olefins, polyalkylene, glycol, and combinations thereof;
d) a silicon oil in the form of polydimethylsiloxane; and
e) a combination of the oils identified in a) to d).

8. The composition of any one of the preceding claims, further comprising a dampening agent that forms up to 30% by weight of the composition.

9. The composition of claim 8, wherein the dampening agent is selected from CaO, Al₂O₃, SiO₂, MnO₂, CaF₂.

10. The composition of any one of the preceding claims, further comprising a gas absorbing agent that forms up to 30% by weight of the composition; and wherein the gas absorbing agent is selected from a group consisting of Bi₂O₃ and CaO.

11. The composition of any one of the preceding claims, further comprising a barrier formation additive, wherein the barrier formation additive is selected from:
a) bismuth, tin, silver, antimony, copper, iron, zinc, aluminium, magnesium, manganese, silicon, germanium, nickel, or any combination of these materials and their oxides; and
b) inorganic and organic acids such as hydrochloric acid, acetic acid, hydrofluoric acid, adipic acid, citric acid, glutaric acid, carboxylic and dicarboxylic acids, phosphoric acid, rosin, oleic acid, and steric acid; and
c) materials that decompose to form acids, such as PTFE (polytetrafluoroethylene), PVC (polyvinyl chloride), and PMAA (poly methacrylic acid).

12. The composition of any one of the preceding claims, wherein the physical state of the composition in the downhole environment is selected from a liquid, a paste and a gel.

13. A method of heating a target region of an oil/gas well, said method comprising:
a) delivering a chemical reaction heat source composition according to any one of claims 1 to 12 into direct contact with well fluids located in the target region of the oil/gas well; and
b) initiating the redox chemical reaction of the composition to generate heat within the target region.

14. The method of claim 13, wherein the composition is pumped to the target region, and preferably the composition is pumped downhole via coiled tubing or via the inner diameter of a well tubing of the oil/gas well.

15. The method of claim 13, wherein the heat source composition is delivered into the target region by a dump bailer that has been deployed down the oil/gas well.

16. The method of any one of claims 13 to 15, wherein the step of initiating the redox chemical reactions comprises:
i) delivering a contained heat source to the target region of the oil/gas well; and
ii) activating the contained heat source to heat the target region and initiate the redox chemical reaction of the composition.

17. The method of claim 16, wherein the contained heat source comprises a chemical reaction heat source housed within an ignition assembly housing.

18. The method of claim 17, wherein under the increased temperatures and/or pressures generated following the activation of the chemical reaction heat source mixture the housing is configured to permit the escape of the chemical reaction heat source contained therein.

19. The method of claim 18, wherein the housing is formed, at least in part, from a material that is configured to melt and/or rupture at the increased temperatures and/or pressures generated by the contained chemical reaction heat source mixture.

20. A method of clearing or removing a well structure from a target region of an oil/gas well by heating the target region using the method of any one of claims 13 to 19.

21. A method of forming a plug and/or seal within a target region of an oil/gas well using the method of heating a target region of an oil/gas well according to any one of claims 13 to 19;
wherein heating the target region serves to melt a well structure within the target region that, upon cooling, combines with residues from the chemical heat source composition to form a plug within the target region.

22. The method of claim 20 or 21, wherein the well structure is selected from a group that consists of: well tubing; well casing; previously deployed well tools; cabling, tubing and other lines deployed within the oil/gas well.

23. The method of forming a plug and/or seal within a target region of an oil/gas well according to claim 21 or 22, further comprising the deployment of a molten alloy onto the plug formed by the melted well structure and residues from the chemical heat source composition.

24. An ignition assembly for use in initiating a chemical reaction heat source to undergo a redox reaction in a downhole environment, said ignition assembly comprising:
a housing containing heating means configured to generate sufficient heat energy to initiate a redox reaction in a chemical reaction heat source;
a piston that is movable from a default position to an active position in which the piston activates the heating means;
wherein, when the pressure acting on the exterior of the housing exceeds a predetermined level, the piston moves from the default position to the active position and activates the heating means.

25. The ignition assembly of claim 24, wherein the piston is arranged in fluid communication with the exterior of the housing such that the piston moves from the default position to the active position when the pressure applied to the exterior of the housing exceeds the predetermined level.

26. The ignition assembly of claim 24 or 25, wherein the piston is retained in the default position by the action of resilient biasing means and/or a shear pin.

27. The ignition assembly of claim 24, 25 or 26, wherein the housing is provided with a conduit that is blocked by a rupture disk that is configured to rupture when the pressure acting on the exterior of the housing exceeds the predetermine level; and
wherein the rupture of the rupture disk facilitates fluid communication between the piston and the exterior of the housing via said conduit.

28. The ignition assembly of any one of claims 24 to 27, wherein the heating means comprises a piezoelectric transducer, a capacitor and a heating element; and
wherein the action of the piston on the piezoelectric transducer creates a voltage that charges the capacitor, which is subsequently discharged to energise the heating element and generate heat to initiate the redox reaction.

29. The ignition assembly of any one of claims 24 to 27, wherein the heating means comprises an injection mechanism loaded with a chemical ignition mixture and a reservoir of redox mixture comprising a metal and an oxidizing reagent; and
wherein the action of the piston on the injection mechanism brings the chemical ignition mixture into contact with the redox mixture, which initiates a heat generating chemical reaction of the redox mixture.
